(19) United States
(12) Patent Application Publication
(10) Pub. No.: US 2017/0091826 A1
(43) Pub. Date: Mar. 30, 2017

(54) Time-related System for Promoting Sales

(71) Applicant: Joseph Neustein, Sherman Oaks, CA (US)

(72) Inventor: Joseph Neustein, Sherman Oaks, CA (US)

(21) Appl. No.: 14/870,994

(22) Filed: Sep. 30, 2015

(51) Int. Cl. G06Q 30/02

(52) U.S. Cl. CPC G06Q 30/0271; G06Q 30/0264

(57) ABSTRACT

A time-related system for promoting retail sales based on the buyer's birthday, wherein the month and day of birth are read as an hour and a minute respectively. This marries the calendar birthday to a specific time on a digital clock and expands the traditional annual birthday promotional opportunity to a daily opportunity. Experienced by every person twice per day, local time at the point of sale, this birthday-minute is in one embodiment used to promote and automatically discount purchases made during that minute or within a few minutes grace period thereof. In another embodiment, the birthday-minute may be extended to become a birthday-hour, expanding the system to the entire hour for all buyers born in the correlated month. In another embodiment, this system creates a direct connection and multiple opportunities for commerce with the buyer through daily contact related to his or her birthday-minute.

### CROSS-REFERENCE TO RELATED APPLICATIONS

(Not Applicable)

### BACKGROUND OF THE INVENTION

Birthdays have been celebrated for thousands of years. The birthday has also become a massive commercial machine. In the world of retail sales promotion, the use of the customer's birthday as a trigger to lure patrons to the premises has long been established, and is often used by restaurants and retail establishments of various kinds. But this method works only once a year.

In an up-to-now unrelated problem, many brick-and-mortar retail and service businesses experience busy times and slack times during the day, and suffer the inefficiency of keeping their premises open, lights on, and workers idle for hours at a time. Fast food restaurants, for instance, often experience lulls between traditional meal times. In the U.S. Pat. No. 6,741,969, Chen describes a complicated auction-based method for solving the problem in restaurants.

In the mass marketing arena, potential customers are often inundated by product offers through emails, through texts, and through voiced telephone calls. It is difficult to get the targets' attention, particularly their welcome attention. It is hard to make a connection with the intended customer and to keep that connection alive.

### BRIEF SUMMARY OF THE INVENTION

This system is a method which translates and extends the annual observance of a person's birthday to a daily or twice daily observance for the purpose of promoting sales.

In this system, the month and day of one's birthday correlate to the hour and minute of one's birthday-minute. For example, January 8^{th} becomes 1:08 (a.m. and p.m.) and August 21^{st} becomes 8:21 (a.m. and p.m.).

Birthday-minute can be a trigger for retail commerce.

At retail, the birthday-minute system is used to automatically discount purchases made at a brick-and-mortar business during the buyer's birthday-minute or within a few minutes grace period thereof. This is a daily, or twice-daily, inducement to buyers—based upon a joyous moment in everyone's life, the birthday. And because birthdays are spread evenly throughout the year, the birthday-minute, along with its enticement to spend, is spread evenly throughout the day.

In another embodiment, birthday-minute is a twice daily 60-second long moment of personal reflection. It is a new kind of personal observance and, along with it, a new way to create both mass market and local promotional opportunities. Through a system of daily contact, the birthday-minute system provides regular interaction with potential buyers, creating a context in which solicitations are woven into the fabric of the personal connection. The individual feels nurtured while the commercial enterprise is fed.

The birthday-minute may also be extended to become a birthday-hour, translating the month of one's birth to an entire hour, both a.m. and p.m.

In summary, this invention improves upon the marketability of the annual birthday celebration, transforming it into a daily opportunity for commerce and for welcomed direct advertising and promotion.

### BRIEF DESCRIPTION OF THE DRAWINGS

FIG. 1 is a flowchart of a basic method of the invention, according to an embodiment.

FIG. 2 is a specific illustration of the method of FIG. 1.

FIG. 3A through 3E are flowcharts depicting aspects of retail and point-of-sale embodiments of the invention.

FIG. 4 is a flowchart depicting an embodiment of the invention involving access to a venue.

FIG. 5 is a diagram depicting a process for accessing the system of the invention, according to an embodiment.

FIG. 6 is a diagram depicting an alternate process for accessing the system of the invention.

FIG. 7A through 7F illustrate a sequence depicting one embodiment of the system.

FIG. 8A through 8F illustrate a sequence depicting another embodiment of the system.

### DETAILED DESCRIPTION OF THE DRAWINGS

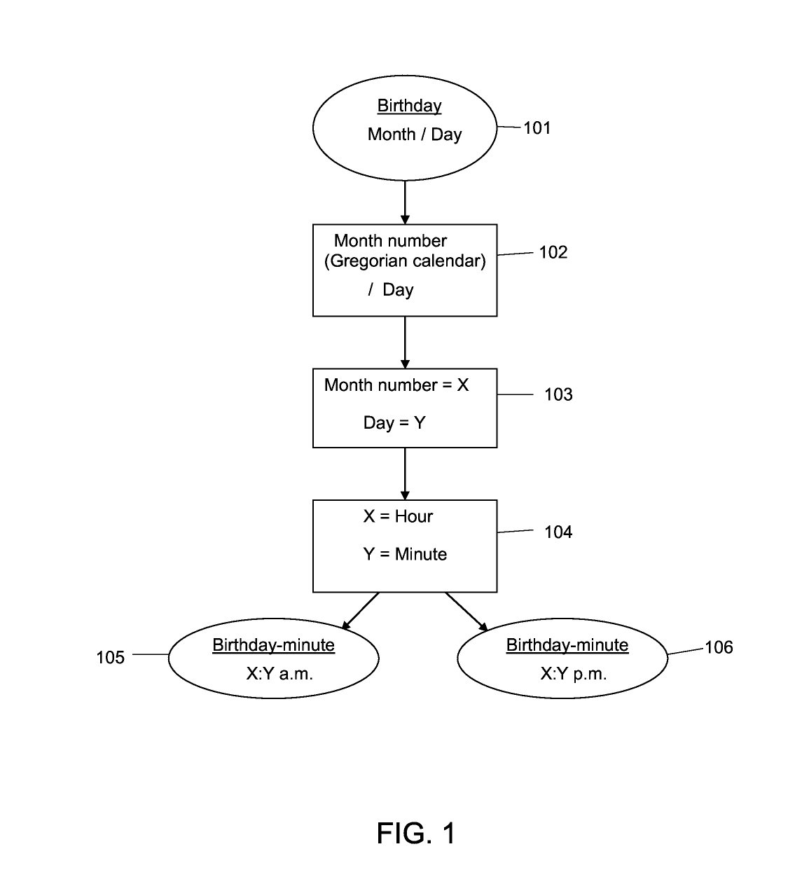

FIG. 1 is a flowchart depicting an underlying concept behind the invention. The diagram shows the process for transforming a person's birthday, celebrated once per year, into that person's birthday-minute, celebrated twice per day, every day of the year. Although this concept is unique, it is quickly graspable.

The person's birthday 101 is purposely not the birth date and consists of only the month and the day, and not the year.

In 102, the birth month is translated into its number in the Gregorian calendar, the calendar most commonly used today.

In 103 and 104, the number of the birth month is transformed into an hour, and the number of the day in that month is transformed into a minute. The pair of numbers, month followed by day, becomes a digital time, hour followed by minute.

In 105 and 106, that hour and minute is expressed as an a.m. time and a p.m. time respectively. This is the person's birthday-minute.

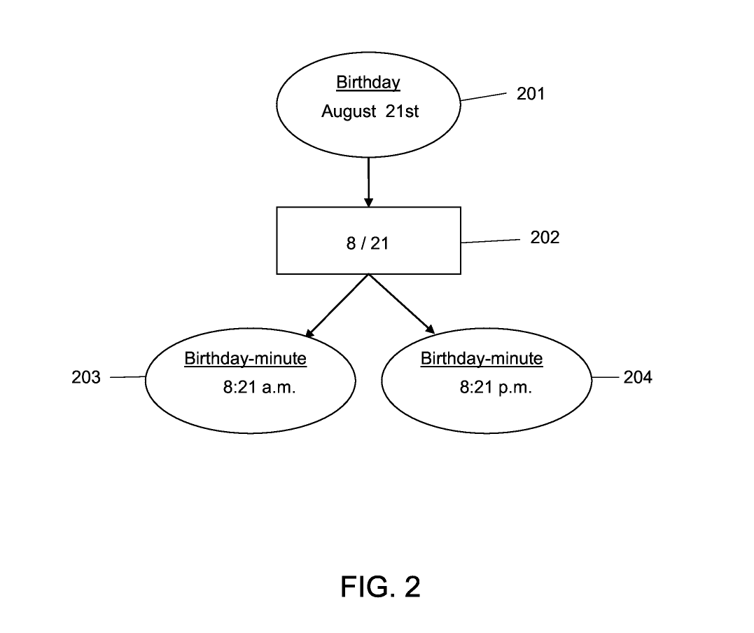

FIG. 2 depicts one example of the process of FIG. 1. The birthday 201, in this case August 21^{st}, is depicted numerically as the compound number 8/21 in 202 and is transformed into the birthday-minute 8:21, observed daily at both 8:21 a.m. and 8:21 p.m., shown in 203 and 204 respectively.

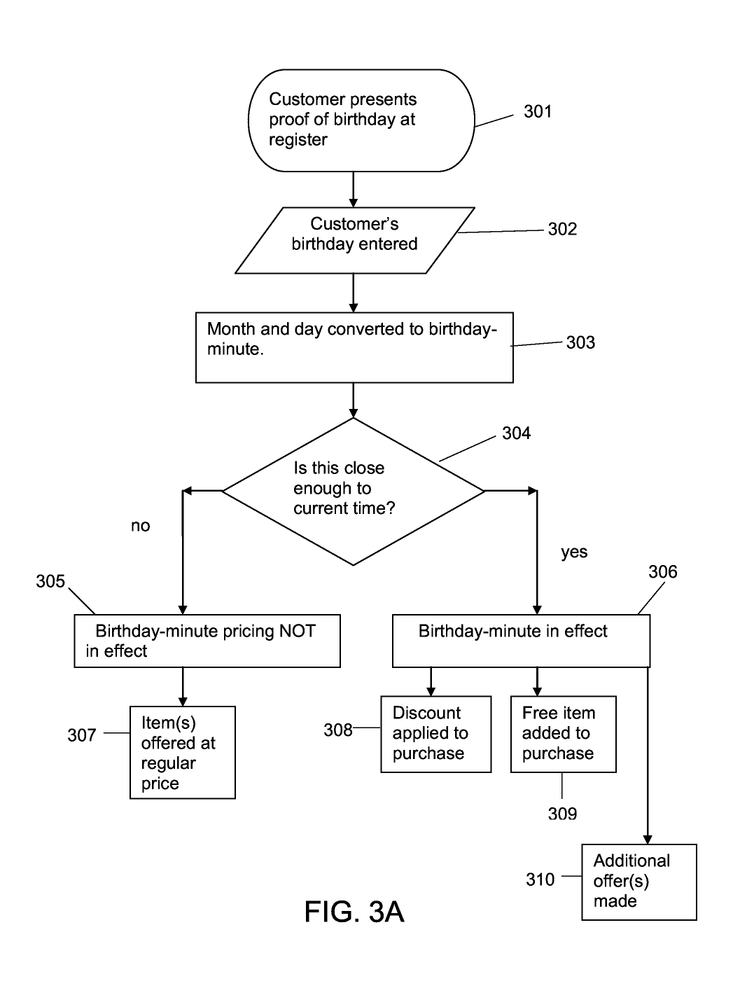

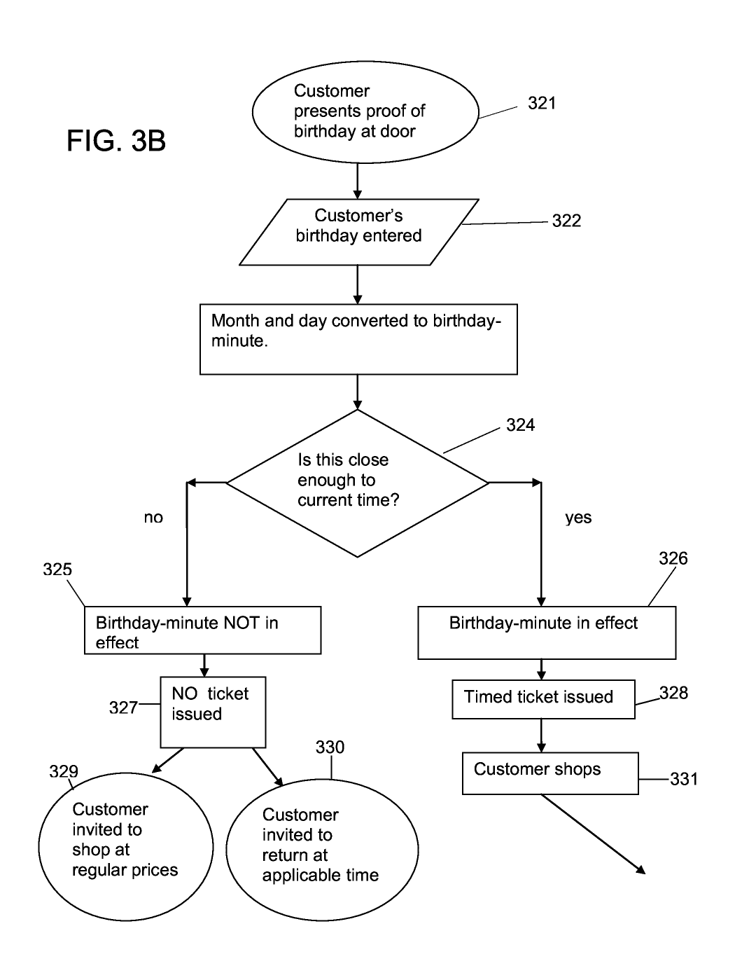

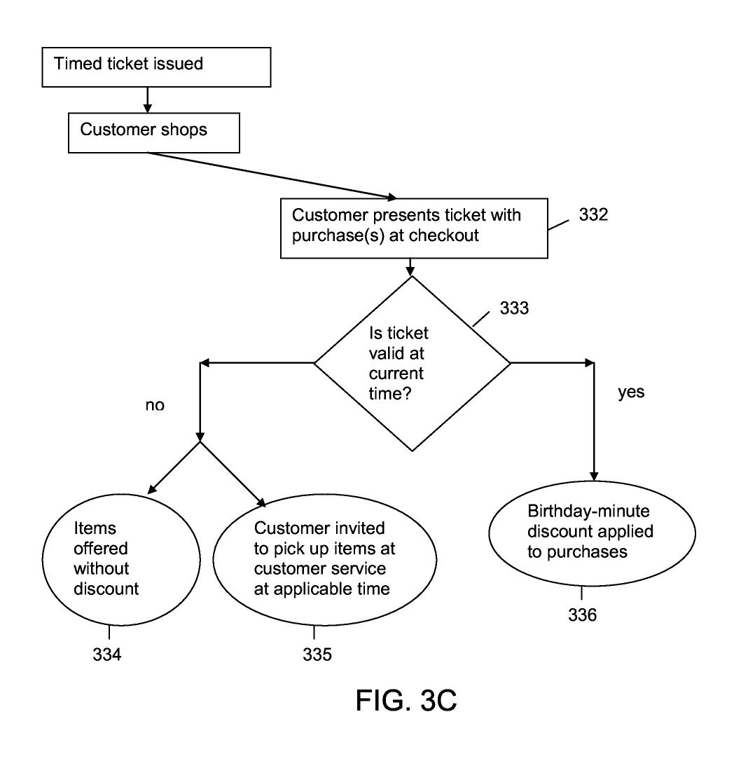

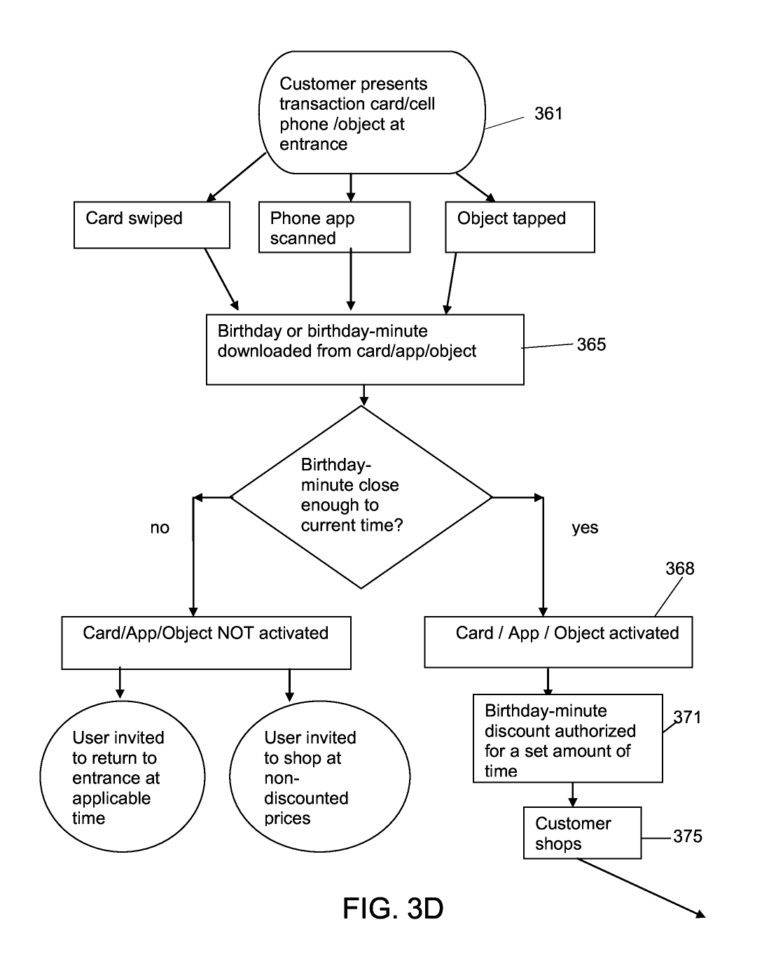

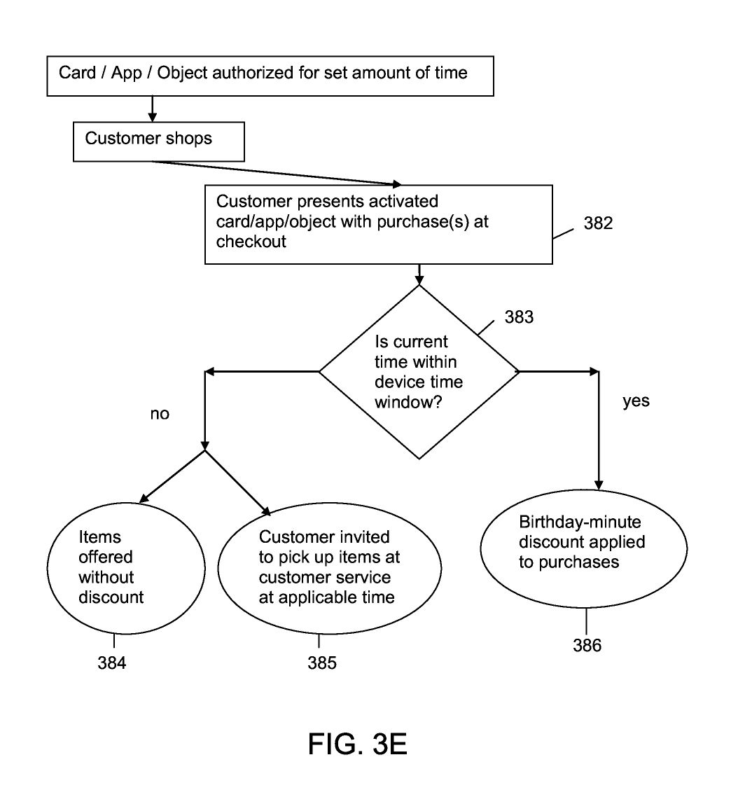

FIG. 3A is a flowchart depicting a use of birthday-minute as the trigger to discount purchases at the point of sale. Purchases made during the buyer's birthday-minute or within a prescribed grace period will be discounted at the register.

At the point of sale in 301, the customer presents some form of identification which contains his or her birthday. This may be a government-issued ID such as a driver's license. It may be a loyalty card issued by the business which links to a specific birthday. It may be a card or other object issued by a third party which contains this information.

In 302, the customer's birthday is entered at the register, typically by the clerk swiping the customer's loyalty card, which contains the customer's birthday, or entering a phone number associated with the card. Alternately, the clerk may swipe the customer's driver's license or similar ID. All the available information contained on it may be automatically inputted into the business's computer. For possible customer privacy concerns, the business may choose not to input certain personal information into its database. This act of refraining from capturing certain data may be a promotable aspect of the transaction.

In 303 and 304, the system checks the customer's birthday-minute against the current local time. If the customer's birthday-minute is within a prescribed grace period of the current time, the applicable discounts will be offered. The grace period may encompass a period of time both before and after the exact time of the birthday-minute. In the case of the birthday-hour, the period will include all minutes within that particular hour and may also include an additional grace period.

When birthday-minute is in effect in 306, the buyer will be offered discount pricing on all items or specified items as in 308 and/or a free item as in 309. A further offer or offers, as in 310, may also be presented to the buyer.

When birthday-minute pricing is not applicable, as in 305, the item will be offered for sale at its regular price in step 307.

FIG. 3B is a flowchart depicting a use of birthday-minute as the trigger to activate the discount for a set length of time, to allow an extended period of shopping. This embodiment is similar in many ways to the embodiment depicted in FIG. 3A of the use of birthday-minute at the point of purchase. While the point-of-sale system of FIG. 3A would be optimal for a fast food restaurant or a convenience store, for example, the system of FIG. 3B would be ideal for a department store or a mall. In step 321, as in step 301, the customer begins the process by presenting a form of identification which contains his or her birthday. The user may present this I.D. at the door, at a customer service counter, at a register, or at another in-store location. When the user's information is inputted in step 322 and it is determined that birthday-minute pricing is in effect at 326, a timed ticket is issued to the user in 328, allotting the user a certain shopping window in which the birthday-minute discount will apply to all his or her purchases or to certain specified items. At step 331, the customer begins shopping, and that sequence continues in FIG. 3C.

In FIG. 3B, when there is a failure to satisfy the requirements of step 324, then in step 325, birthday-minute would not be in effect and in 327, no ticket would be issued. The customer would be invited to shop at regular prices 329 or return at a time when his or her birthday-minute applies 330.

In the successful, ticketed shopping situation shown in FIG. 3C, when the user brings various items to checkout at 332, the ticket will be inputted to ascertain that the current time is within the window, with a possible grace period, at 333, and that the birthday-minute is in effect. The user may then buy the item or items at the discount in step 336. If it is determined that the ticket is no longer timely, the customer may buy the items at their regular price 334 or pick up his or her chosen items at a convenient storage location, typically customer service, at another time coinciding with his or her birthday-minute 335.

FIG. 3D is a flowchart depicting an extended shopping situation as in FIG. 3B but with one difference: the user begins this process at step 361 by presenting a card, cell phone, or other object which both verifies the user's birthday and can be activated for a set length of time. In step 365, the user's birthday-minute is either downloaded from the device or ascertained from the birthday downloaded from it. Employing this device obviates the necessity of issuing a ticket, as in step 328 in FIG. 3B. Instead, if the user's birthday-minute is close enough to the current time, the device itself is activated in FIG. 3D step 368, and is authorized for a set length of time in step 371. In step 375, the user begins to shop, and this shopping sequence continues in FIG. 3E.

FIG. 3E is a flowchart depicting the continuation of the shopping experience of FIG. 3D, employing the user's device authorized for a set amount of time 371. In this embodiment, the user shops and then presents his or her activated device along with his or her purchases at checkout 382. If the current time is within the time window set on the device, with a possible grace period, at 383, then the birthday-minute discount will be applied to the user's purchases in step 386. If the current time falls outside the authorized window, the buyer will be offered the opportunity to buy the items without the birthday-minute discount 384 or to return at an applicable time to buy those items at the discounted price at a nearby location, such as a customer service desk 385.

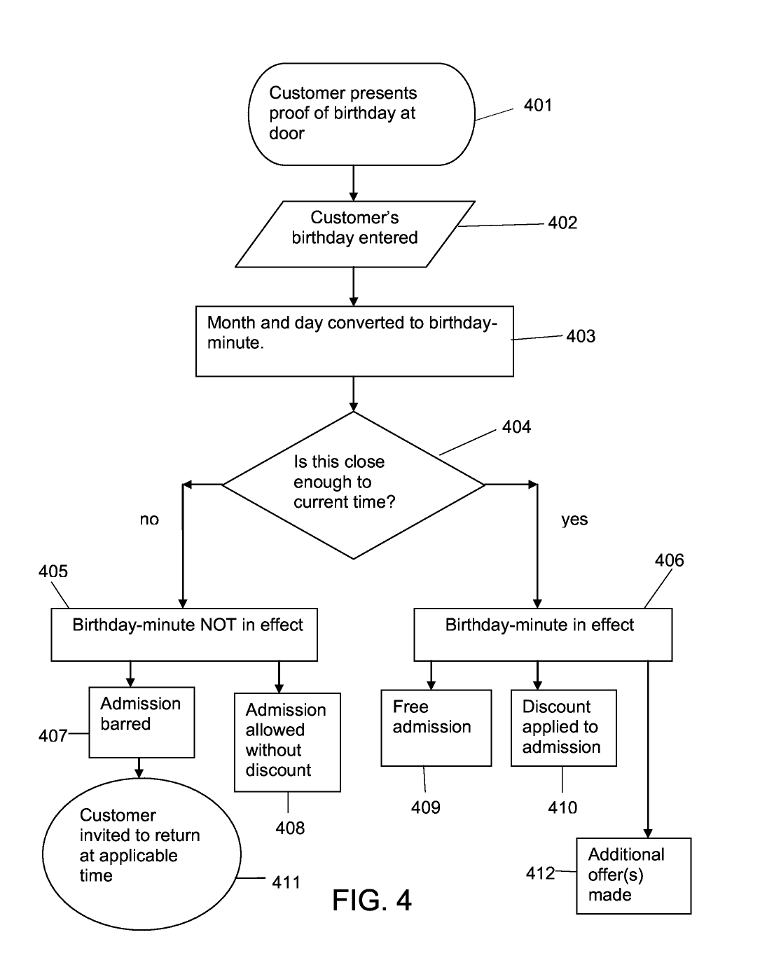

FIG. 4 is a flowchart depicting a use of birthday-minute as the trigger to control entry into and/or discount admission fees to any number of venues, including but not limited to theaters, museums and auto shows. Patrons who present themselves at the door during their birthday-minute or within a prescribed grace period will in one embodiment be allowed entry and in another be admitted for a discounted fee.

At the entryway in 401, the customer presents some item which identifies his or her birthday. This may be a government-issued ID such as a driver's license. It may be a loyalty card issued by the venue or a ticket issued by the event organizer which links to a specific birthday. It may be a card or other item issued by a third party which contains this information. It may be a cell phone containing a verified birthday-minute app. It may be a portable or wearable object such as a fob or a wristband which functions as an ID.

In 402, the customer's birthday is entered at the door, typically by the clerk swiping the customer's loyalty card, scanning his or her ticket, or tapping his or her object. Alternately, the clerk may swipe the customer's driver's license or similar ID. In the last case, the available information contained on it may be automatically inputted into the computer of the venue or that of the event organizer. For possible privacy concerns, the controlling entity may choose not to input certain information into its database. This eschewing of the capture of this personal information may be a promotable aspect of the transaction.

In 403 and 404, the system checks the customer's birthday-minute against the current local time. If the customer's birthday-minute is within a prescribed grace period of the current time as in 406, entry will be allowed for free in 409 or at a discount in 410. The grace period may encompass a period of time both before and after the exact time of the birthday-minute. In the case of the birthday-hour, the period will include all minutes within that particular hour and may also include an additional grace period.

When birthday-minute is in effect in 406, the buyer will always be offered discounted admission as in 410 or free admission as in 409. A further offer or offers, as in 412, may also be presented to the buyer.

When the current time is outside acceptable limits for birthday-minute pricing as in 405, admission will be allowed for full price in one embodiment 408 and barred entirely in another, as in step 407. When admission is barred, the customer may be invited to return during his or her birthday-minute in step 411.

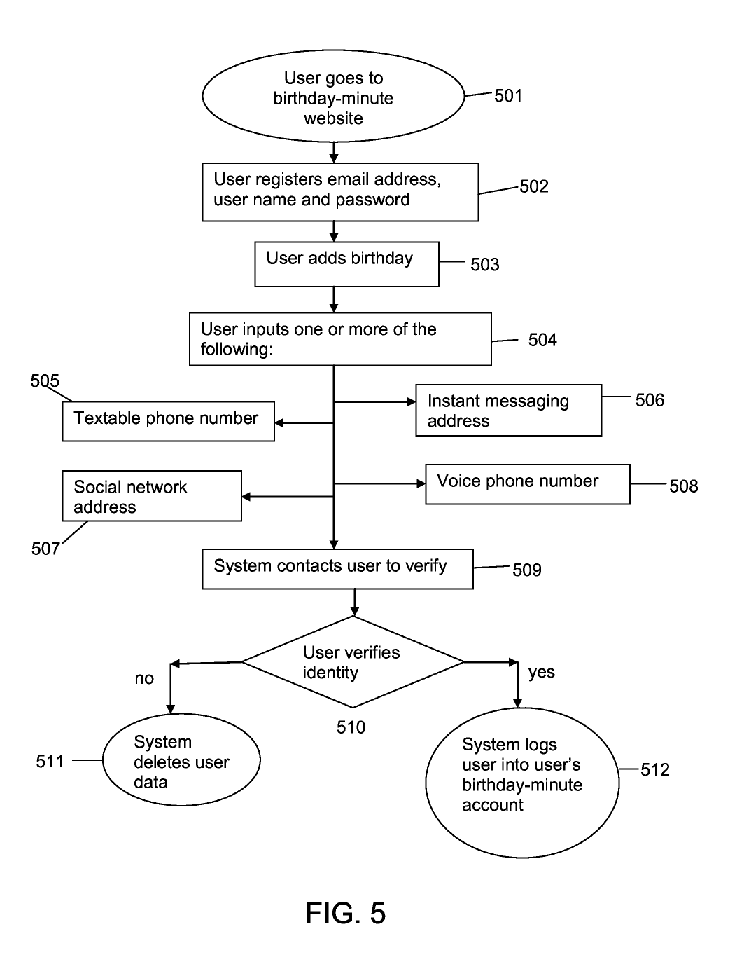

FIG. 5 is a depiction of a method for users to enroll in an embodiment of the invention, the birthday-minute network, via the Internet—using either a computer or a smart phone. The birthday-minute network combines aspects of branding, direct marketing, and self-help coaching to form an online community which may be outside the aegis of a retailer or group of retailers. In 501, this user contact may be in response to an online ad or to an email or text message directed at the potential user, either broadly or as a byproduct of the user's interaction with an entity connected to the birthday-minute network. Once at the website 502, the user inputs his or her email address and selects a user name and password. At that point 503, the user adds his or her birthday—month and day but not year. The user in 504 chooses a mode of communication for his or her birthday-minute alerts. Three anticipated modes of network interaction with the user are text messaging 505, instant messaging 506, and automated voice phone calling 508. It is expected that future technological advances will allow social networking 507 to also be a viable time-sensitive link, but until then, it still can be a useful tool in other aspects of the system. Once the information is inputted, the system employs that selected mode and contacts the user to verify that the information is correct 509. In step 510, the user either verifies the information or not. If verification is unsuccessful, the system deletes the inputted user data 511. If the user does verify the data, the user is logged into the system and directed to his or her birthday-minute account 512. Once there, the user can personalize the various elements of the user's birthday-minute alert.

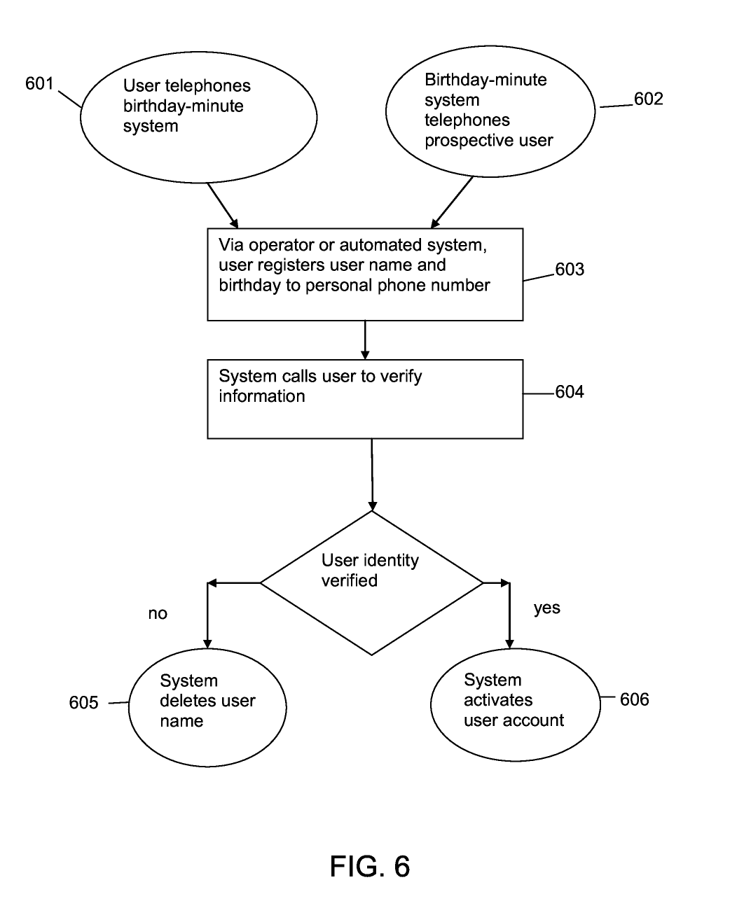

FIG. 6 depicts a method for landline phone users to enroll in the voice call mode of the network via the user's voice telephone itself. This is useful primarily for the 16% of the adult U.S. population that does not have access to the Internet. Though the landline system is designed primarily for the 36% of U.S. adults who do not have smart phones, most of this group has access to the Internet and may be able to enroll in the system online as in FIG. 5, step 508.

In addition to the landline enrollment method depicted in FIG. 5, step 508, the prospective landline user may alternately use his or her landline to enroll in the system in one of two ways, either by calling into the system from his or her phone 601 or by answering a call from the system 602. In either case, the prospective user must register his or her name and birthday, linking that information to the user's telephone number 603. In either case, the call is terminated at this point, and the system re-phones the user to verify the information 604. If the person who answers the phone successfully verifies the information, the system activates the user account 606. If the person is unable to do so, the information and user name are deleted 605.

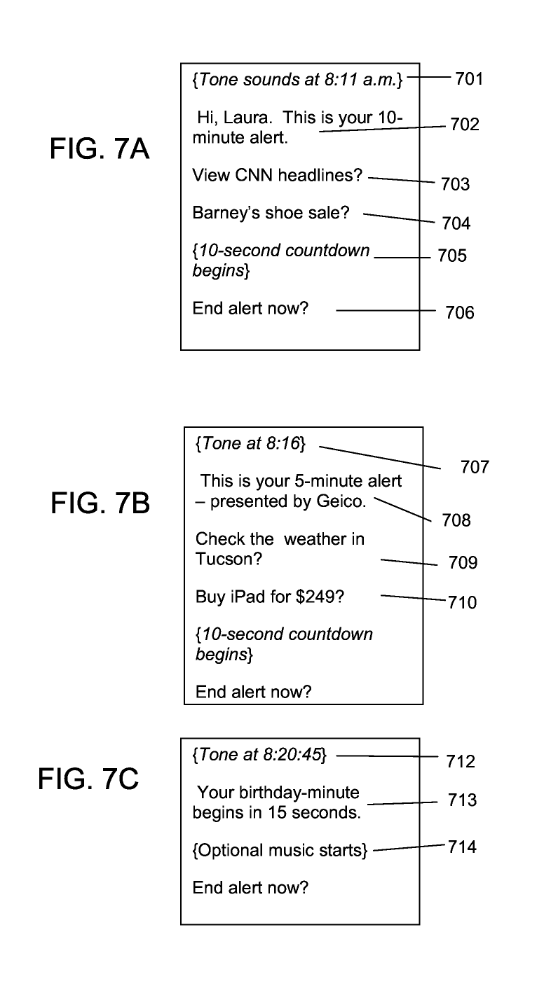

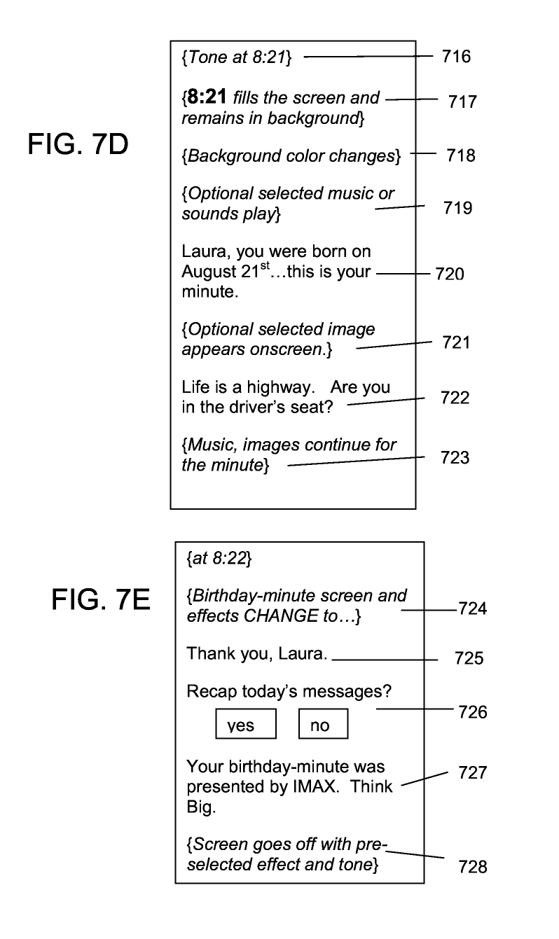

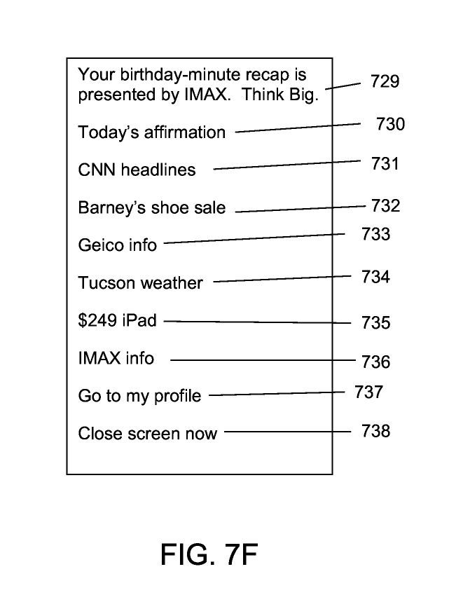

FIG. 7A through FIG. 7E are depictions of message screens designed to alert a typical user to his or her birthday-minute. They are designed primarily as text messages to cell phones but can also be sent to computers via instant messaging. The messages in this example are intended for a specific user named Laura who was born on August 21^{st} and celebrates her birthday-minute at 8:21 a.m. and 8:21 p.m. Through the information she inputted into her online profile, the system knows Laura watches CNN, buys high-end clothing, travels often to Tucson, etc.

FIG. 7A is Laura's ten-minute a.m. alert and is scheduled for 8:11 a.m. in step 701. Laura, in her online profile, has requested her first a.m. warning at ten minutes. [Her p.m. alert may, for example, be preceded by a one-hour warning, then a half-hour warning, then a ten-minute warning.] The onscreen messages are superimposed over the birthday-minute logo in 702. Line 703 is the first clickable element in the message.

In this example, it's a link to a news service Laura has chosen in her profile. Line 704 links to a Barney's page. If line 703 or 704 is not clicked in seven seconds, the screen ends with a 10-second countdown 705. The numbers fill the screen one at a time behind the foreground text. As the seconds elapse, the numbers change per a user-selected effect. The large variety of screens, fonts, and effects allows the user to personalize the experience. Line 706 is an option, which is included at the bottom of several alert screens, for the user to end that alert and close the screen immediately.

FIG. 7B is Laura's five-minute alert, set for 8:16 a.m. in 707. Per line 708, it is sponsored. Line 709 is a link to an item, targeted to the user. Line 710 presents a deeply discounted offer, again targeted.

FIG. 7C is the 15-second alert screen. In this case, it appears and a tone sounds at 8:20:45, per step 712. The 15-second announcement appears onscreen and may also be spoken aloud 713. If music is selected 714, it typically begins at this point and continues through the birthday-minute screen itself.

FIG. 7D is Laura's birthday-minute screen. In this embodiment, the birthday-minute screen contains no advertising or marketing messages. In another embodiment, advertising, marketing, news headlines, sports scores, etc., are included. Per line 716, when the user's birthday-minute begins, a preselected tone sounds and the time, in this case, 8:21, fills the screen 717. The font and style of the numbers may be preselected by the user. The screen may change color 718. Laura's chosen music plays 719. The birthday-minute announcement 720 appears onscreen and may also be spoken aloud. The voice may be prerecorded by Laura or by someone she has chosen, or it can be one of the voices of the birthday-minute alert system, optionally preselected by Laura. An optional image or photo provided by the user or selected by the user may appear onscreen 721. After a few seconds, an affirmation or piece of advice appears onscreen 722. The source of this content may vary. It may be a self-help reminder supplied by the user or a message supplied by the system or a message created by the system with input from the user. The music and images continue throughout the minute 723.

FIG. 7E is the screen that follows the user's birthday-minute. At the end of the birthday-minute, in step 724, the screen image and music change. The user is always thanked 725 and given an opportunity to see a list of that day's birthday-minute messages 726. If the user clicks on “yes,” a new scrollable recap screen appears. It contains all of the clickable elements included in the associated birthday minute and its alerts. If the user clicks “no,” or clicks neither box for seven seconds, the sponsor's message 727 appears. It remains for an additional seven seconds, after which the screen goes off with a preselected effect 728.

FIG. 7F is an example of a recap screen. It begins with the sponsor's message 729 and that day's affirmation 730 and contains links to the clickable elements of the most recent birthday-minute and the alerts leading up to it, 731-736. It also contains a link to the user's profile 737. Each of these pages features a clickable element which will return the user to the recap screen. At any point, the user may click on line 738 and close the screen.

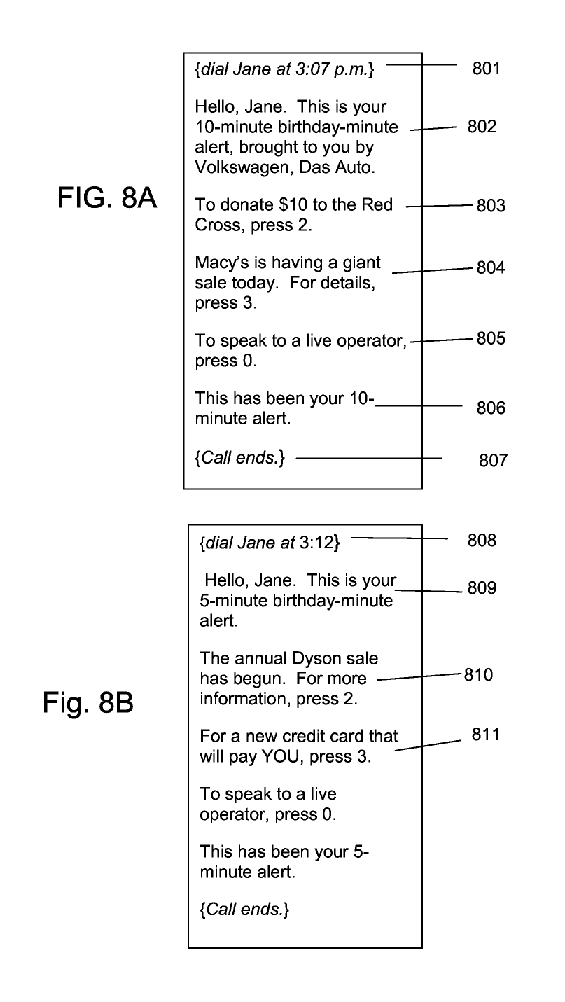

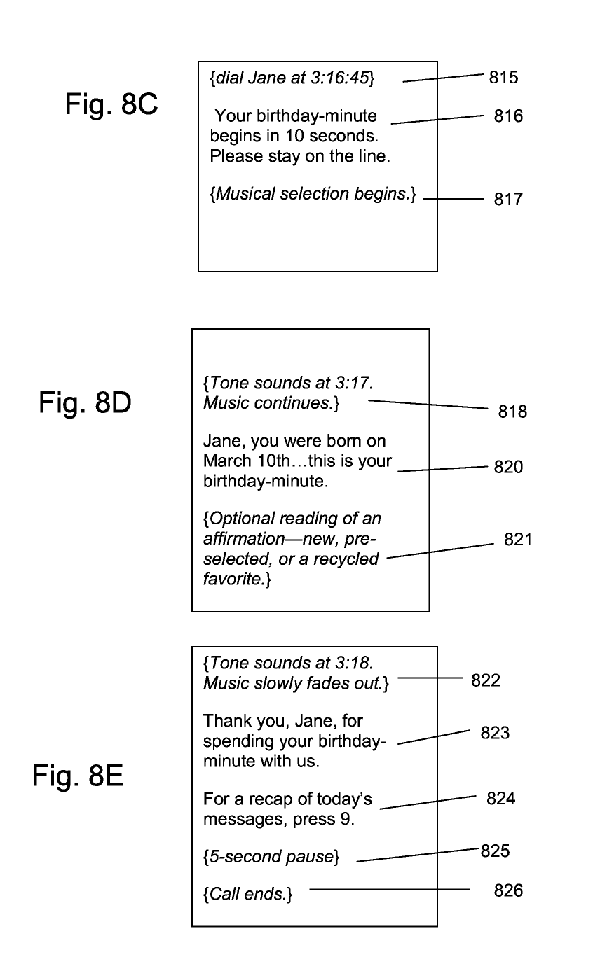

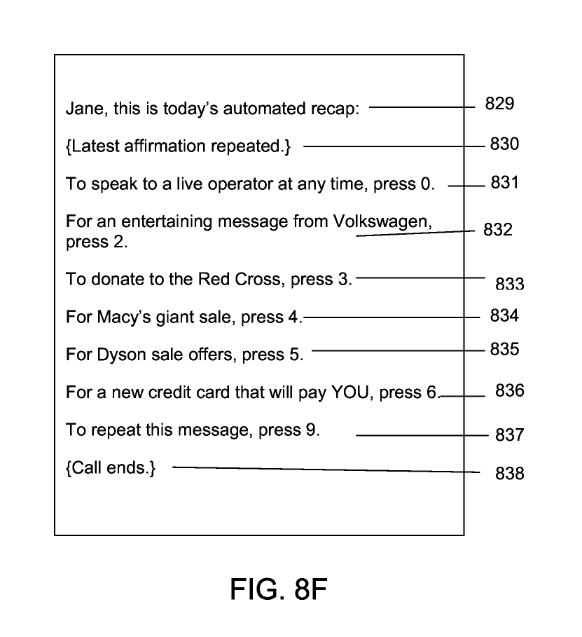

FIG. 8A through FIG. 8E illustrate a typical sequence of automated phone calls that comprise a landline birthday-minute alert. The user in this example is Jane who was born on March 17^{th}.

In Jane's user profile, she has chosen to celebrate her birthday-minute each day at 3:17 p.m. and has chosen a ten-minute and a five-minute countdown alert. The ten-minute alert rings at 3:07 p.m. per line 801. Line 802 includes the user's first name, the length of time until her birthday-minute and a marketing message. Line 803 is a request for a charitable donation linked to an operator bank. Line 804 is a piece of marketing linked to an automated message. Per 805, a live operator is available. When the wait time is longer than optimum, an automated message on that line offers to have an operator call the user back at a later time. The foregoing elements may not be included in every call, and some calls may include additional elements. The closing line 806 comes four seconds after line 805, and it is immediately followed by the call disconnecting 807.

FIG. 8B depicts Jane's five-minute alert. It begins at step 808 with a call to Jane at 3:12 p.m. and the opening announcement 809. The five-minute alert contains two paid messages 810 and 811, optimally targeted to Jane.

FIGS. 8C, 8D, and 8E represent one extended phone call. It rings 15 seconds before Jane's birthday-minute on step 815, and it includes Jane's 3:17 p.m. birthday-minute call, and a post-birthday-minute wrap-up. In this embodiment, this extended call contains no commercial messages. In another embodiment, the call does include commercial messages.

In FIG. 8C, the 10-second alert at step 816 serves to prepare Jane for her birthday-minute, and it introduces her birthday-minute music 817. This music has been supplied by the system or preselected by Jane as part of her user profile. On step 818, a tone signals the beginning of her birthday-minute.

As shown in FIG. 8D, the birthday-minute announcement itself begins with the initiating tone 818 at 3:17 and includes the announcement 820 and an affirmation or piece of advice 821. Each of these elements, like the music, can be automatically supplied by the system or personalized by the user. In one embodiment, the user chooses options at the website; in another, choices are made via an automated phone line; and in another, they are made with the help of a live operator.

In FIG. 8E, the wrap-up begins with a special tone sounding at step 822 to mark the ending of the 60-second birthday minute. The wrap-up always includes a thank-you message 823 and a number to press for a recap of that day's messages 824. This is followed by a 5-second pause 825 and the termination of the call 826.

FIG. 8F is an example of the automated phone recap reached by pressing 9 per line 824 in FIG. 8E. This recap contains that day's affirmation 830 and lists the messages contained in the user's most recent birthday-minute call and the alerts leading to it, 832-836. Line 837 is an offer to repeat the recap. If no numbers are pressed, the system waits five seconds and terminates the call 838.

If the birthday-minute call is answered by the user's voicemail, the system will typically leave a phone number for the user to call for an automated recap of that day's birthday-minute messages.

If the birthday-minute call goes unanswered, the system may retry the call, postpone the call until later that day, or cancel the call for that day, according to the option chosen by the user in the user's profile.

Although the foregoing invention has been described in some detail by way of illustration and example, it will be readily apparent to those of ordinary skill in the art in light of the teachings of this invention that certain changes and modifications may be made thereto without departing from the spirit or scope of the appended claims.

What is claimed is:

1. A time-related system for promoting sales, comprising:
taking the buyer's birthday, expressed as the calendar number of the month followed by the number of the day;
translating this pair of numbers to a specific time, both a.m. and p.m., as exemplified by the birthday August 21^{st} being expressed as 8/21 and translated to 8:21 a.m. and 8:21 p.m.;
observing each of these two times, every day of the year, as the person's birthday-minute; and
using this birthday-minute as the trigger at participating places of business to automatically or manually discount prices of all or specified items purchased during that minute, or within a certain grace period thereof, local time.

2. The system of claim 1, where the reading of the user's birthday-minute upon entry to a business initiates the issuance of a birthday-minute discount ticket for that business, valid for a set amount of time.

3. The system of claim 1, where the reading of the user's birthday-minute upon entry to a business initiates the activation of any device capable of activation for a set amount of time for the purpose of birthday-minute-priced purchasing, these devices including but not limited to:
the user's loyalty card for that business;
the user's cell phone;
the user's bank card; or
a card, object, or garment related to a particular business.

4. The system of claim 1, where the device which is activated is also the device through which the sales are transacted.

5. The system of claim 1, wherein the user's birthday-minute is the trigger that automatically or manually allows entry into a venue or allows entry for a reduced price into a venue during that minute or within a certain grace period

6. The system of claim 1, where the birthday-minute is extended to become a birthday-hour, expanding the system to the entire hour for all persons born in the correlated month.

7. A time-related system for direct marketing, comprising:
taking the target's birthday, expressed as the calendar number of the month followed by the number of the day;
translating this pair of numbers to a specific time, both a.m. and p.m., as exemplified by the birthday August 21^{st} being expressed as 8/21 and translated to 8:21 a.m. and 8:21 p.m.;
observing each of these two times, every day of the year, as the person's birthday-minute;
alerting the target to each occurrence of his or her birthday-minute;
offering the target opportunities to buy products or services specially priced within a prescribed window of time; and
authorizing the target to act upon any or all of these opportunities online or at one or more of a number of physical locations.

8. The system of claim 7, wherein the target is alerted to his or her birthday-minute via a message or signal to any device capable of receiving such a message or signal, including but not limited to:
a text to the user's cell phone;
an automated or live operator call to the user's landline telephone;
an instant message; or
a message sent to the user's social networking address.

9. The system of claim 7, where advertising or promotions are attached to the birthday-minute message.

10. The system of claim 7, where news, sports, entertainment, or announcements of various kinds are attached to the birthday-minute message.

11. The system of claim 7, where affirmations or various kinds of advice are attached to the birthday-minute message.

12. The system of claim 7, where any of the attachments in claims 9-11 are sponsored attachments.

13. The system of claim 7, where the birthday-minute message is preceded by a countdown message or series of messages.

14. The system of claim 7, where advertising or promotions are attached to the countdown.

15. The system of claim 7, where news, sports, entertainment, or announcements of various kinds are attached to the countdown.

16. The system of claim 7, where affirmations or various kinds of advice are attached to the countdown.

17. The system of claim 7, where any of the attachments in claims 14-16 are sponsored attachments.

18. The system of claim 7, where the birthday-minute is extended to become a birthday-hour, expanding the system to the entire hour for all targets born in the correlated month.
